(19) United States
(12) Patent Application Publication
(10) Pub. No.: US 2002/0129017 A1
(43) Pub. Date: Sep. 12, 2002

(54) Hierarchical characterization of fields from multiple tables with one-to-many relations for comprehensive data mining

(76) Inventors: David Kil, Gilroy, CA (US); Brian Gregory, Newbury Park, CA (US)

Correspondence Address: WELSH & KATZ, LTD, 120 S RIVERSIDE PLAZA, 22ND FLOOR, CHICAGO, IL, 60606, US

(21) Appl. No.: 10/090,271

(22) Filed: Mar. 4, 2002

Related U.S. Application Data
(60) Provisional application No. 60/274,008, filed on Mar. 7, 2001.

(51) Int. Cl. G06F 7/00

(52) U.S. Cl. 707/6

(57) ABSTRACT

A method, system, and article of manufacture for transforming a relational database having a hierarchical parent-child structure into a flat database more amendable to conventional data mining techniques. Generate a hierarchical data tree based on a relational data model. Perform a bottom-up summarization starting from the children and proceeding to the next higher level. Append to parent records new fields summarizing the contents of child records associated therewith. Also a computer system comprising means for performing these functions.

### PRIORITY CLAIM

This application claims the benefit of U.S. Provisional Application Ser. No. 60/274,008, filed Mar. 7, 2001, which is herewith incorporated herein by reference. This application is related to co-pending application Ser. No. 09/945,530, entitled “Automatic Mapping from Data to Preprocessing Algorithms” filed Aug. 30, 2001 (attorney docket number 7648/81349 00SC105,111), which is herewith incorporated herein by this reference. This application is also related to co-pending application Ser. No. 09/942,435, entitled “Data Mining Application with Improved Data Mining Algorithm Selection” filed Nov. 16, 2001 (attorney docket number 7648/81348 00SC106), which is herewith incorporated herein by this reference. This application is also related to co-pending application Ser. No. Not Yet Assigned, entitled “Method and Apparatus for One-Step Data Mining with Natural Language Specification and Results,” filed the same day as this application, which is incorporated herein by reference. This application is also related to co-pending application Ser. No. Not Yet Assigned, entitled “Data Mining Apparatus and Method with Graphic User Interface Based Ground-Truth Tool and User Algorithms,” filed the same day as this application, which is incorporated herein by reference.

### TECHNICAL FIELD

This invention relates generally to knowledge discovery in data and data mining software application. More specifically this invention relates to an apparatus and method for hierarchical characterization of fields from multiple tables with one-to-many relations for comprehensive data mining. An embodiment is a method to summarize or characterize information scattered over multiple tables that are related through one or more many-to-one relationships.

### BACKGROUND ART

In general, a field is a specified area used for a particular class of data elements on a data medium or in storage. A record comprises set of data elements treated as a unit. A data medium is material in or on which data can be recorded and from which data can be retrieved. Storage is a functional unit into which data can be placed, in which they can be retained, and from which they can be retrieved.

A data element is a unit of data that, in a certain context, is considered indivisible. Data is a reinterpretable representation of information in a formalized manner suitable for communication, interpretation, or processing. Information, in information processing, is knowledge concerning objects, such as facts, events, things, processes, or ideas, including concepts, that within a certain context has a particular meaning.

A functional unit is an entity of hardware or software, or both, capable of accomplishing a specified purpose. Hardware is all or part of the physical components of an information processing system. Software includes all or part the programs, procedures, rules, and associated documentation of an information processing system. An information processing system is one or more data processing systems and devices, such as office and communication equipment, that perform information processing. A data processing system includes one or more computers, peripheral equipment, and software that perform data processing.

A computer is a functional unit that can perform substantial computations, including numerous arithmetic operations and logic operations without human intervention. A computer can consist of a stand-alone unit or can comprise several interconnected units. In information processing, the term computer usually refers to a digital computer. A computer that is controlled by internally stored programs and that is capable of using common storage for all or part of a program and also for all or part of the data necessary for the execution of the programs; performing user-designated manipulation of digitally represented discrete data, including arithmetic operations and logic operations; and executing programs that modify themselves during their execution. To store is to retain data in a storage device. A computer program is syntactic unit that conforms to the rules of a particular programming language and that is composed of declarations and statements or instructions needed to solve a certain function, task, or problem. A programming language is an artificial language (a language whose rules are explicitly established prior to its use) for expressing programs.

In a database, a record typically contains data regarding one instance, event, example, or the like. It is a data structure that is a collection of fields (which may also be called elements, features, or attributes), each with its own name and type. The elements (fields) of a record represent different types of information and are accessed by name. A record can be accessed as a collective unit of elements, or the elements can be accessed individually. A record contains an ordered set of fields. Records represent different entities with different values for the attributes represented by the fields. In relational database management systems, records can be visualized as rows in a table.

A database field is a location in a record in which a particular type of data is stored. It is an element of a database record in which one piece of information is stored. For example, EMPLOYEE-RECORD might contain fields to store Last-Name, First-Name, Address, City, State, Zip-Code, Hire-Date, Current-Salary, Title, Department, and so on. Individual fields are characterized by at least their maximum length and the type of data (for example, alphabetic, numeric, or financial) that can be placed in them. Fields may be of a fixed width (bits or characters) or they may be separated by a delimiter character, often comma (CSV) or HT (TSV). In relational database management systems, fields can be visualized as columns in a table.

A database is a collection of data arranged for ease and speed of search and retrieval. A table is an orderly arrangement of data, especially one in which the data are arranged in columns and rows in an essentially rectangular form. A database can contain multiple tables. Each database table is a file composed of records, each of which contains fields, together with a set of operations for searching, sorting, recombining, and other functions.

Previously disclosed work relating to hierarchical data representation in a relational database concerns how to present and visualize hierarchically structured information. Such previous work may disclose, for example, a system for the visualization of and navigation though data hierarchies. Such data hierarchies can be generated based on a pre-determined level of parent-child tree depth.

One example of such work teaches to provide a design tool for designing an application interface. The design tool includes a graphical user interface (GUI) that visually represents a hierarchy of data and the relationships between the data. Thus, the design tool eliminates the need for an interface designer to have independent knowledge of the structure of the data (i.e., the data fields and relationships between the data). The design tool's GUI represents the data and the relationships between the data in a hierarchical display referred to as a data palette. An output hierarchy comprised of output levels is created as the user selects fields from the data palette to be displayed in the application's interface. When a data field is selected, the design tool automatically determines the appropriate interface component and output level of the output hierarchy using the relationships defined for the data. Output levels are associated with interface components that comprise the application's interface.

A second example of such work is a method and system for generating an interactive, multi-resolution presentation space of information structures within a computer enabling a user to navigate and interact with the information. The presentation space is hierarchically structured into a tree of nested visualization elements. A visual display is generated for the user which has a plurality of iconic representations and visual features corresponding to the visualization elements and the parameters defined for each visualization element. The user is allowed to interact in the presentation space through a point of view or avatar. The viewing resolution of the avatar is varied depending on the position of the avatar relative to a visualization element. Culling and pruning of the presentation space is performed depending on the size of a visualization element and its distance from the avatar.

A third example of such work discloses a system that includes a relational database management system having a data modeling component. A “data model” in that disclosure is a graphical representation of the relationship between tables one may use in a design document. “Design documents” allow a user to customize how his or her data are presented, including presenting information in formats which are not tabular and including formats which link together different tables (so that information stored in separate tables appears to the user to come from one place). Methods are described for automatically linking tables to be placed in a data model by comparing unique keys (e.g., primary key or other unique identifier) of one table with indexes (or indexable fields) of another table. Based upon the comparison, the system automatically suggests an appropriate link (if any) for the tables.

A fourth example of such work shows a method, system, and computer program product that provides data visualization which optimizes visualization of and navigation through hierarchies. A partial hierarchy is generated and displayed. The partial hierarchy consists of a number of levels at least equal to a predetermined depth and less than the total number of levels included in a corresponding complete hierarchy. Parent nodes in the bottom level of the partial hierarchy have segments of connection lines extending toward child nodes not included in the partial hierarchy. A user is permitted to mark selected nodes or locations in a displayed partial hierarchy. Partial hierarchies are generated and stored in a cache or generated on-the-fly. Each partial hierarchy ends at a progressively deeper level. An interpolator interpolates a partial hierarchy layout by interpolating corresponding nodes in two partial hierarchies. A hierarchy manager manages partial hierarchies in response to requests from a viewer to move a camera to camera positions. Partial hierarchies are fetched from the cache or the interpolator. A display then displays display views of fetched partial hierarchies corresponding to the camera positions. During free-form navigation, a hierarchy manager determines and maintains an orientation based on at least one reference object. During zooming, an angular orientation is maintained through successive partial hierarchies. Mapping is also provided between a three-dimensional 3D partial hierarchy and a two-dimensional 2D overview of a complete hierarchy.

Many data mining tools require that input fields have a one-to-one relationship with the selected output fields. This restriction makes unavailable for data mining fields that have many-to-one relationships with the selected output fields. This restriction can and in at least some circumstances does degrade data mining performance.

There is a need, therefore, for an approach that can summarize many-to-one data relationships by hierarchically decomposing them using various techniques such as time series summarization techniques, statistical summarization techniques, digital signal processing, and image processing. There continues to exist a need for an approach to summarize or characterize information scattered over multiple tables that are related through one-to-many relationships.

### DISCLOSURE OF INVENTION

The invention, together with the advantages thereof, may be understood by reference to the following description in conjunction with the accompanying figures, which illustrate some embodiments of the invention.

One embodiment is a method of preparing a relational database having a many-to-one relationship for data mining. The method includes the following steps. Generate a hierarchical data tree based on a relational data model. Perform a bottom-up summarization starting from the children and proceeding to the next higher level, ending at the parent or root node.

Another embodiment is a method of including many records in a child level with one record in a parent level for data mining. This second embodiment method includes the following steps[DK1]. Identify a parent-level record. Select child-level records corresponding to the parent-level record. Characterize the child-level records into a transformed field. The transformed field can be one of a plurality of transformed fields. Append the transformed field to the parent-level record. The method can also include the following steps. Provide a record class for the child-level records. For each record class, provide a characterizing function that can summarize the child-level records succinctly. Categorize the selected child as members of the record class, wherein the categorize step uses the characterizing function to determine the transformed field. Providing a record class can include the steps: provide as a first class time series records with a regular sampling interval, the characterizing function associated with the first class of records being a selected from the group of digital signal processing algorithms consisting of local cosine transform coefficients and linear predictive coding coefficients; provide as a second class time series records having an irregular sampling interval, the characterizing function associated with the second class of records begin selected from the group consisting of trend analysis, Markov modeling, and statistical summarization; and provide as a third class of miscellaneous records having no apparent time dependence, the characterizing function associated with the third class of records being selected from the group consisting of statistical summarization and data association.

Another embodiment is a method of preparing a relational database for data mining as a flat database. In includes the following steps. Generate a hierarchical data tree based on a relational data model. Perform a bottom-up summarization of the data scattered across multiple tables. Also, use a single table containing the summarized data for data mining.

Another embodiment is a method of preparing a relational database for data mining as a flat database. Identify a data model. Generate a data hierarchy tree. Collect multiple events in child records associated with a parent record. Characterize the nature of multiple events in the child record. Extract features from the child records, where feature extraction depends on the nature of the multiple events in the child records. Append extracted features to the parent record. Then, repeat the method for all child records.

Another embodiment is a method for transforming a relational database to a flat database. Provide a relational database having a first table and a second table. Each table has a plurality of records and each record has a plurality of fields. A linked field in a selection record in the first table contains data corresponding to data in a linking field of a plurality of records in the second table. Characterize the data in a summarized field in the second table by computing summarization data, where the summarized field in the second database is not the linking field. Append a summarization field to the first table. Store the summarization data in the summarization field of the selection record in the first table. The method can also repeat the characterizing step and the appending step for all records in the first table.

Another embodiment is a method of applying a data mining technique for a flat database to a relational database. Provide a relational database having a parent table, parent-table records, a child table, and child-table records. One or more child-table records can be linked to a parent table record. Convert the relational database to a flat database by appending to a parent table record at least one field summarizing the values in child table records linked to the parent table. Apply a flat database data mining technique to the flat database.

Another embodiment is a method to determine the relationships among tables in a database. Identify potential primary key fields. Determine table hierarchy that identifies tables as parent tables and related child tables. Explore intractable data relationships to reduce the size of a data table. Explore inter-table data relationships between data in a parent table and data in a child table to that parent.

Another embodiment is a method to identify potential primary key fields. Identify a redundant field whose name appears in a plurality of tables. Identify as a parent table a table in which the value of the redundant field is unique for each record. The redundant field is a primary key for the parent table. Select as a parent record a record from the parent table. The value of the redundant field of the parent record is unique in the parent table. Select as child records all records in tables other than the parent table for which the value of the redundant field is the same as the value of the redundant field in the parent record. Identify as a child table a table that is not the parent table and that has the redundant field.

Another embodiment is a computer system that can prepare a relational database having a many-to-one relationship for data mining. It includes a means for performing the steps in the above-summarized methods. Another embodiment is a computer readable medium article of manufacture with instructions for the purpose of preparing a relational database having a many-to-one relationship for data mining. The medium includes instructions that when executed perform the methods summarized above.

Another embodiment is a memory for storing data for analysis by a data mining application. The memory includes but is not limited to: a data structure stored in the memory and comprising a flat database table. It also includes a primary record in the database table reflecting one instance of a set of fields of data. The record is associated with a plurality of secondary records in a linked database table. It also includes a raw data field in the database table containing raw data stored in the table and a transformed data field in the database table containing transformed data, the transformed data field in the primary record representing the plurality of secondary records associated with the primary record. The transformed data field can be a statistic summarizing the values of the plurality of records associated with the primary record or a computed transformation of the values of the plurality of records associated with the primary record.

### BRIEF DESCRIPTION OF DRAWINGS

Several aspects of the present invention are further described in connection with the accompanying drawings in which:

FIG. 1 is a program flowchart depicting an example of a sequence of operations in a program for hierarchical characterization of fields from multiple tables with one-to-many relations for comprehensive data mining.

FIG. 2 is a system flowchart depicting the control of operations and data flow in one embodiment of a system for hierarchical characterization of fields from multiple tables with one-to-many relations for comprehensive data mining.

FIG. 3 is a system flowchart depicting the control of operations and data flow in one embodiment of a system for extracting children features from a child table in a relational database using characteristics of the data for function selection.

FIG. 4 is a data model depicting one example of the structure and relationships in a relational database for an example database.

FIG. 5 is a pair of windows depicting an example of a suitable graphical user interface for hierarchical characterization of fields from multiple tables with one-to-many relations for comprehensive data mining.

### MODES AND BEST MODE FOR CARRYING OUT THE INVENTION

While the present invention is susceptible of embodiment in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” object is intended to denote also one of a possible plurality of such objects.

One embodiment generates a hierarchical data tree based on a relational data model. It can perform bottom-up data summarization so that data mining can include and be impacted by all linked data scattered across multiple tables. The summarization process starts from “leaf” or “child” nodes in a hierarchical data table structure, then proceeds to the next higher level.

After identifying parent-child nodes, categorize the child-level records into one of the several (for example, three) record classes, such as time series with regular sampling interval, time series with irregular sampling interval, and miscellaneous collection of records. Associated with each record class can be a library of algorithms that can be used to summarize information contained in the child-level records. For example, if the child-level records contain periodic LDL/HDL (low-density lipoprotein and high-density lipoprotein) cholesterol ratios for each patient with demographic data, the child-level records can be summarized compactly using trend-analysis techniques and the summarization fields can be included into the parent-level records to allow data mining to commence at an appropriate level of abstraction.

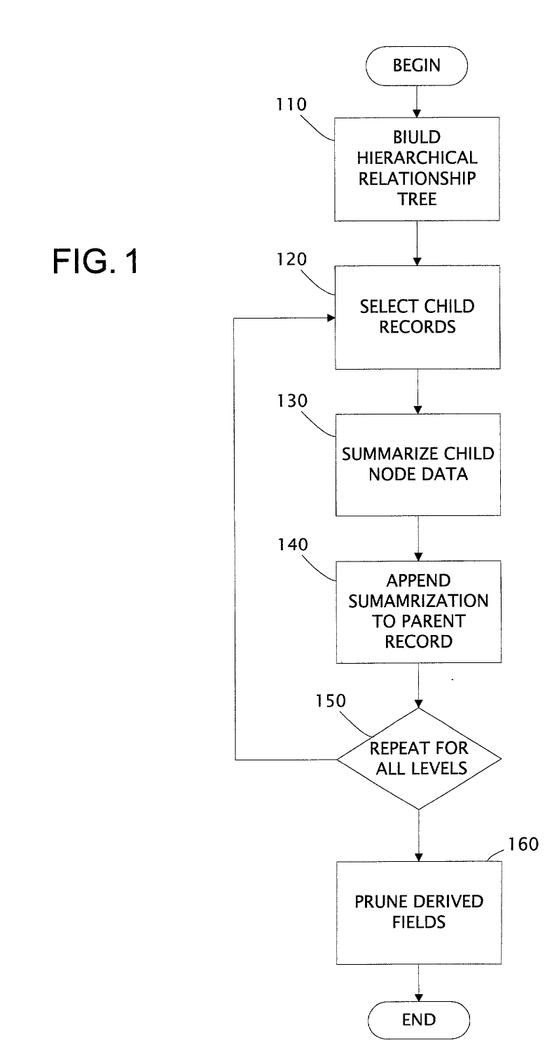

Referring now to FIG. 1, there is depicted a flowchart illustrating the sequence of operations and flow of control in a process for summarizing fields with a many-to-one relationship to the selected dependent variable. Control passes first to a build-hierarchical-relationship-tree process (110), which analyzes parent-child relationships between and among tables and records in a relational database. The build-hierarchical-relationship-tree process (110) identifies a parent record in a parent table and child records in a child table, associated with that parent record. Control passes to a select-child-records process (120), which selects the child records associated with the parent record. Control passes to a summarize-child-node-data process (130), in which the contents of the child nodes are summarized in a way that can be tailored to the type of contents in the child node. The summarization can include, for example, statistical computations or similar modeling taking advantage of various transformation algorithms appropriate for the particular type of data found. Control passes to an append-summarization-to-parent process (140), in which new fields are added to the parent record, the new fields containing the values calculated to summarize the child records. The entire sequence can repeat for all levels (150) until the entire hierarchical tree has been analyzed. Control can pass to a prune-derived-fields process (160), which can apply algorithms to eliminate redundant or otherwise non-useful information from the expanded records containing summarization fields.

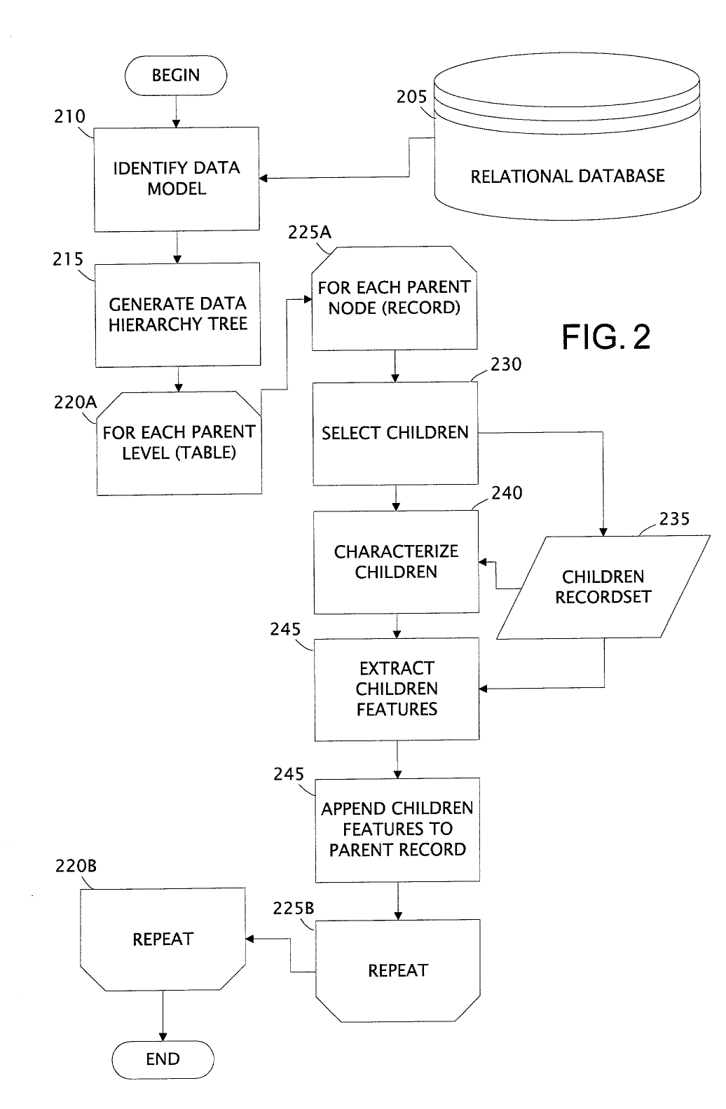

Referring now to FIG. 2, there is depicted a system flowchart illustrating the control of operations and the data flow of a system for hierarchical characterization of fields from multiple tables with one-to-many relations for comprehensive data mining. The system flowchart includes data symbols to indicate the existence of data; process symbols to indicate the operations to be executed on data, as well as to define the logical path to be followed; and line symbols to indicate data flow between processes and/or data media as well as the control flow between processes. A relational database (205) contains information in multiple tables comprising fields and records, the tables having a hierarchical relationship of parent tables containing unique parent records and child records containing a plurality of child records corresponding to each unique parent record. Control passes to an identify-data-model process (210) that analyzes the relational database (205) to determine the hierarchical relationship of data therein. Control passes to a generate-data-hierarchy-tree process (215), which models the parent-child structure of data in the relational database (205) as identified by the identify-data-model process (210). Control passes to a for-each-parent-level-(table) loop (220A), which starts at the topmost parent table level and with each iteration descends to the next parent-child level in the relational database (205). Control passes to a nested for-each-parent-node-(record) loop (225A), which selects in turn each unique record identifying a parent node that can have corresponding child records in a child table. Control within the nested loops passes to a select-children process (230), which identifies and selects for processing the child records associated with the parent record of the current loop. The select-children process (230) creates or identifies a children recordset (235), which comprises all the child records associated with the parent record of the current loop. Control within the nested loops passes to a characterize-children process (240), which identifies the type of data stored in the child record in order to facilitate identifying an appropriate function for summarizing that data. Control passes to an extract-children-features process (245) that computes a feature or features characterizing the records of the children recordset (235). The feature or features may be a statistical measure or some other transform. The particular feature or features calculated may depend on the type of data stored in the children recordset (235), as identified by the characterize-children process (240). Control passes to an append-children-features-to-parent-record process (245), which expands the parent record to include a new field or fields to contain the feature or features calculated by the extract-children-features-process (245). Control passes to a first repeat process (225B) that passes control back to the beginning of the for-each-parent-node-(record) loop (225A) until that loop has completed. Control passes to a second repeat process (220B) that passes control back to the beginning of the for-each-parent-level-(table) loop process (220A) until the all tables have been analyzed. Summarization proceeds in a bottom up manner from the leaf nodes to the parent nodes.

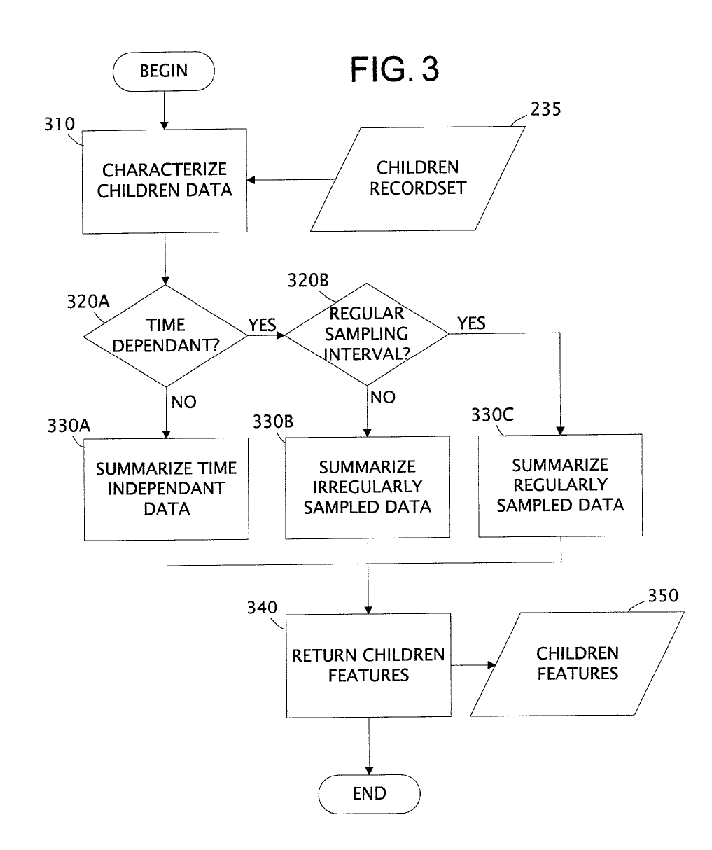

Referring now to FIG. 3, there is shown a system flowchart illustrating the control of operations and the data flow of a system for extracting features from children recordset data (235). Children recordset data (235) is provided, containing a set of records related by all being children of a common parent. A characterize-children-data process (310) examines the children recordset data (235) to categorize it into one of the predetermined types. Examples of data types are illustrated herein, but the method of FIG. 3 is equally applicable to other useful categories and types of data. If, for example, the data is not time dependent (320A), control passes to a summarize-time-independent-data process (330A) that can apply appropriate functions such as statistical summarization and data association to compute features. As one example of data association, assume that the database is filled with items purchased. If a customer buys one particular item, data association seeks to determine what else that customer is likely to buy. If buys an expensive car, what else is the customer likely to purchase? Are there other customers who fit a similar profile? What are their demographic characteristics? Can a data mining application user predict cross-selling or up-selling opportunities based on associating customer's purchase behavior with what is learned from associating purchase behavior with future shopping habits? Such queries provide one way to summarize data.

If, for example, time dependent data does not reflect a regular sampling interval (320B), control passes to a summarize-irregularly-sampled-data process (320B) that computes a feature or features of the children recordset by applying an appropriate processing algorithm such as trend analysis, Markov modeling, statistical summarization, regression analysis, interpolation to turn data into regularly sampled data (most regular sampling techniques apply), phase map, and others. For time dependent data reflecting a regular sampling interval, for example, control passes to a summarize-regularly-sampled-data process (330C), which computes a feature or features applying appropriate techniques such as various digital signal processing algorithms so that the time series can be characterized in terms of local-cosine transform coefficients, linear predicting coding, Fourier transform, wavelet transform, wavelet packets, Gabor transform, time-frequency distribution,and the like. Control passes to a return-children-features-process (340) that returns children features data (350) to a calling program. Furthermore, a set of time-dependent features can be extracted that capture attributes specific to a finite number of fixed time intervals (e.g., regression coefficients that characterize 6-month time-series trends). In such a case, multiple fields, each corresponding to a specific period of time, can be appended to the parent-level records.

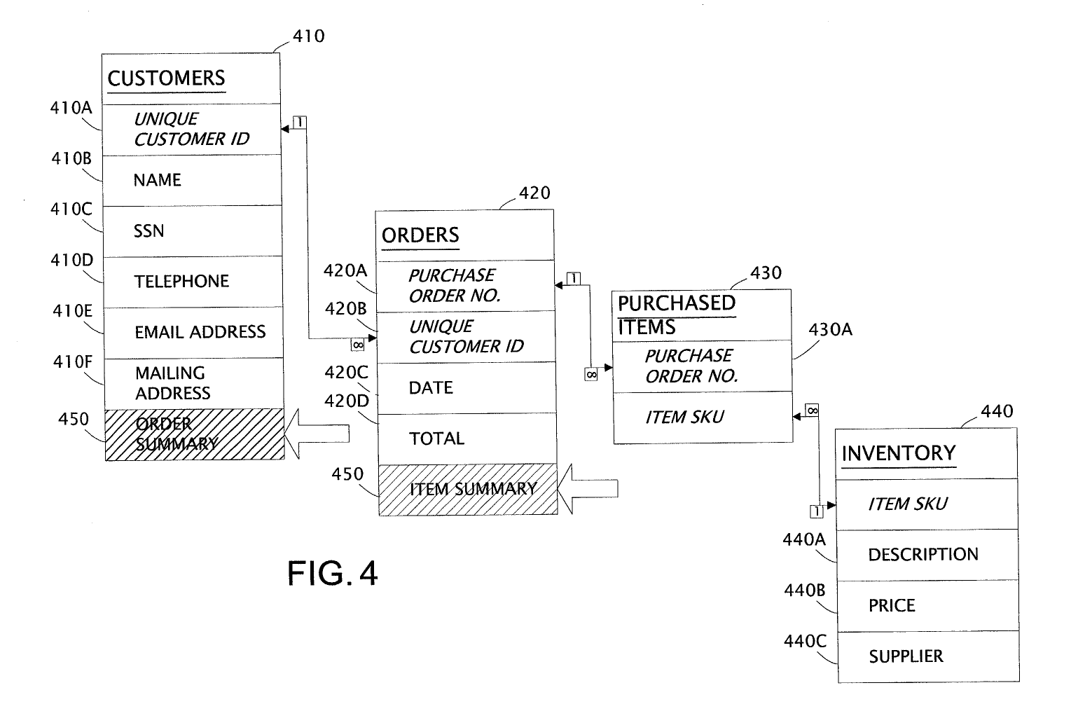

Referring now to FIG. 4, there is depicted a model of a relational database illustrating many-to-one relationships and summarization fields. This model reflects information of a type that a typical business might be interested in tracking. A customer table (410) includes fields containing information about customers, such as a unique customer id field (410A), a name field (410B), a social security number field (410C), a telephone number field (410D), an email address field (410E), and a mailing address field (410F). Each record corresponds to a particular customer and each field in a record contains information about that customer. An orders table (420) is a child of the customer table (410). Each customer can place an unlimited number of orders over time, and each order is associated with only one customer. A record in the orders table (420) corresponds to a particular order by a customer. The record in the orders table (420) is linked to the corresponding customer by containing the same unique customer id data in a unique customer id field (420B). The orders table (420) can also include order data such as a purchase order number field (420A), a date field (420C) and a total field (420D) containing, for example, the total price, tax, and shipping and handling. A purchased items table (430) can list all items actually purchased. A record for an item purchased can be associated with a particular purchase order by a linked purchase order number field (430A), and can uniquely identify the item by, for example, an item stock-keeping unit (“SKU”) in an item SKU field (430B). The information in the item SKU field can in turn link to an inventory table (440) which can also contain, for example, a description field (440A) describing the item, a price field (440B) listing the price of the item, and a supplier field (440C) identifying the product supplier.

Referring still to FIG. 4, fields can be summarized in a bottom up manner using the method described above. This summarization process results in the addition of a calculated item summary field (450) to the order table (420) to summarize all items on a particular order. More than one such item summary field can be included. For example, such a field could contain information such as the number of items in a particular order or the average cost of items in an order. The summarization process continues and adds one or more order summary fields (450) to the customer table, which may contain statistical or summarization data such as average order price for a given customer, number of orders for a given customer, and/or data reflecting the seasonal nature of orders. This information in a flat table may now be submitted to a conventional data mining process.

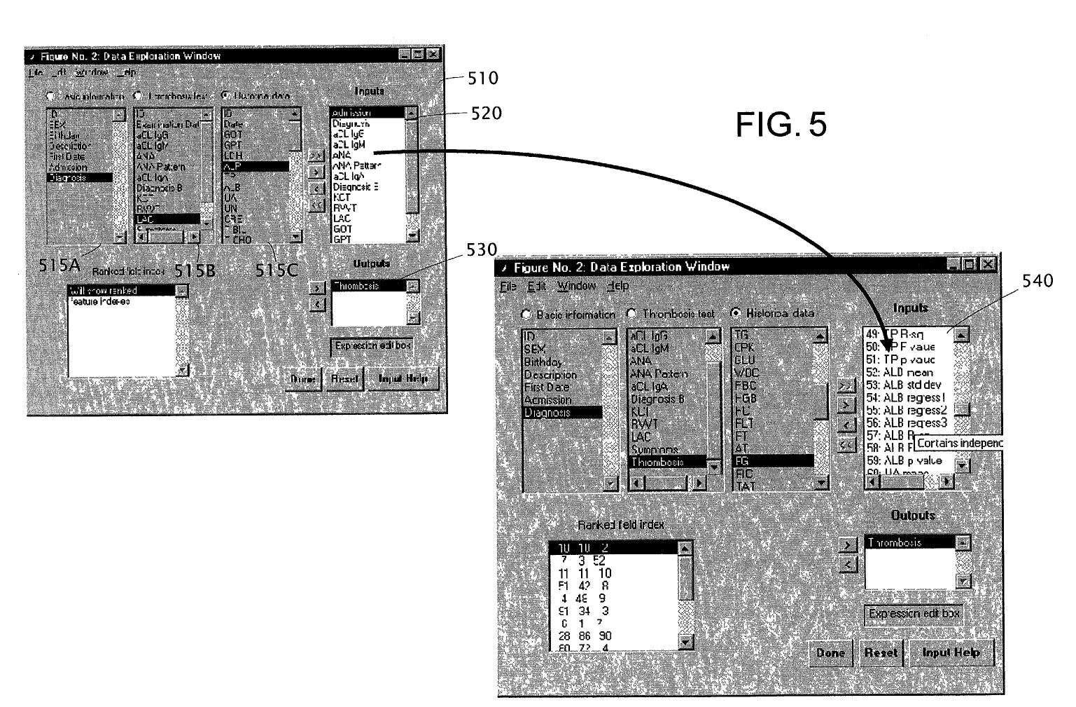

Referring now to FIG. 5, there are depicted a pair of windows usable as a graphical user interface in a method and system for hierarchical characterization of fields from multiple tables with one-to-many relations for comprehensive data mining. Windows can include conventional elements and controls, such as a task bar, a minimize button, a maximize button, a restore button, and others. A data exploration window (510) includes list boxes for each table in a database. In this example of a data set concerning diagnosis of thrombosis, tables include basic information shown in a basic information table listbox (515A), thrombosis test data shown in a thrombosis test table listbox (515B), and historical data shown in a historical data table listbox (515C). Each listbox (515A, 515B, 515C) lists the fields from the respective tables. An inputs listbox (520) contains fields that the user selects for input fields for data mining. An outputs listbox (530) contains user-selected output fields, here the actual diagnosis of thrombosis. The program can automatically evaluate data stored in a hierarchical database and recommend inputs in a transformed inputs listbox (540) that summarize the relevant data, permitting application of flat-table data mining techniques to a relational database.

In the example depicted in FIG. 5, the actual data are scattered in three tables. The historical data table contains medical history data for each patient over time at an irregular sampling interval. The fields in the historical data table are related to a primary key of patient identification in the basic information table and the thrombosis test table by a many-to-one relationship. Fields are selected from the historical data table. A hierarchical-summarization algorithm gathers all the historical data associated with each patient. The hierarchical summarization algorithm then computes trend-related and statistical parameters, and appends them to the selected fields from the thrombosis test table. This capability allows the user to exploit all of the data scattered over multiple tables in order to maximize data-gathering performance.

While the present invention has been described in the context of particular exemplary data structures, processes, and systems, those of ordinary skill in the art will appreciate that the processes of the present invention are capable of being distributed in the form of a computer readable medium of instructions and a variety of forms and that the present invention applies equally regardless of the particular type of signal bearing computer readable media actually used to carry out the distribution. Computer readable media includes any recording medium in which computer code may be fixed, including but not limited to CD's, DVD's, semiconductor ram, rom, or flash memory, paper tape, punch cards, and any optical, magnetic, or semiconductor recording medium or the like. Examples of computer readable media include recordable-type media such as floppy disc, a hard disk drive, a RAM, and CD-ROMs, DVD-ROMs, an online internet web site, tape storage, and compact flash storage, and transmission-type media such as digital and analog communications links, and any other volatile or non-volatile mass storage system readable by the computer. The computer readable medium includes cooperating or interconnected computer readable media, which exist exclusively on single computer system or are distributed among multiple interconnected computer systems that may be local or remote. Those skilled in the art will also recognize many other configurations of these and similar components which can also comprise computer system, which are considered equivalent and are intended to be encompassed within the scope of the claims herein.

Although embodiments have been shown and described, it is to be understood that various modifications and substitutions, as well as rearrangements of parts and components, can be made by those skilled in the art, without departing from the normal spirit and scope of this invention. Having thus described the invention in detail by way of reference to preferred embodiments thereof, it will be apparent that other modifications and variations are possible without departing from the scope of the invention defined in the appended claims. Therefore, the spirit and scope of the appended claims should not be limited to the description of the preferred versions contained herein. The appended claims are contemplated to cover the present invention any and all modifications, variations, or equivalents that fall within the true spirit and scope of the basic underlying principles disclosed and claimed herein.

### Industrial Applicability

An embodiment of the invention can improve performance and offer more flexibility in data analysis. An embodiment can be usefully employed in data-mining products, services, and licensing opportunities.

1. A method of preparing a relational database having a many-to-one relationship for data mining, the method comprising the steps:
generate a hierarchical data tree based on a relational data model and
perform a bottom-up summarization starting from the children and proceeding to the next higher level.

2. A method of including many records in a child level with one record in a parent level for data mining, the method comprising the steps:
identify a parent level record;
select child-level records corresponding to the parent level record;
characterize the child-level records into a transformed field; and
append the transformed field to the parent-level record.

3. The method according to claim according to claim 2 wherein the transformed field is one of a plurality of transformed fields.

4. The method according to claim according to claim 2 further comprising the steps:
provide a record class;
provide a characterizing function associated with the record class; and
categorize the selected child as members of the record class;
wherein the step categorize step uses the characterizing function to determine the transformed field.

5. The method according to claim 3 wherein provide a record class step includes the steps:
provide as a first class time series records with a regular sampling interval, the characterizing function associated with the first class of records being a selected from the group of digital signal processing algorithms consisting of local cosine transform coefficients and linear predictive coding coefficients;
provide as a second class time series records having an irregular sampling interval, the characterizing function associated with the second class of records begin selected from the group consisting of trend analysis, Markov modeling, and statistical summarization_{;;;;} and
provide as a third class of miscellaneous records having no apparent time dependence, the characterizing function associated with the third class of records being selected from the group consisting of statistical summarization and data association.

6. A method of preparing a relational database for data-mining as a flat database, the method comprising the steps:
generate a hierarchical data tree based on a relational data model;
perform a bottom-up summarization of the data scattered across multiple tables; and
use a single table containing the summarized data for data mining.

7. A method of preparing a relational database for data-mining as a flat database, the method comprising:
identify a data model;
generate a data hierarchy tree;
collect multiple events in child records associated with a parent record;
characterize the nature of multiple events in the child record;
extract features from the child records, where feature extraction depends on the nature of the multiple events in the child records;
append extracted features to the parent record; and
repeat the method for all child records.

8. A method for transforming a relational database to a flat database, the method comprising the steps:
provide a relational database having a first table and a second table, each table having a plurality of records, each record having a plurality of fields, wherein a linked field in a selection record in the first table contains data corresponding to data in a linking field of a plurality of records in the second table;
characterize the data in a summarized field in the second table by computing summarization data, wherein the summarized field in the second table is not the linking field; and
append a summarization field to the first table; and
store the summarization data in the summarization field of the selection record in the first table.

9. The method according to claim 8 further comprising the step: repeat the characterizing step and the appending step for all records in the first table.

10. A method of applying a data mining technique for a flat database to a relational database, the method comprising the steps:
provide a relational database having a parent table, parent-table records, a child table, and child-table records, wherein a plurality of child table records can be linked to a parent table record;
convert the relational database to a flat database by appending to a parent table record at least one field summarizing the values in child table records linked to the parent table; and
apply a flat database data mining technique to the flat database.

11. A method to determine the relationships among tables in a database, the method comprising the steps:
identify potential primary key fields;
determine table hierarchy that identifies tables as parent tables and related child tables;
explore intractable data relationships to reduce the size of a data table; and
explore inter-table data relationships between data in a parent table and data in a child table to that parent.

12. A method to identify potential primary key fields, the method comprising the steps:
identify a redundant field whose name appears in a plurality of tables;
identify as a parent table a table in which the value of the redundant field is unique for each record, whereby the redundant field is a primary key for the parent table;
select as a parent record a record from the parent table, whereby the value of the redundant field of the parent record is unique in the parent table;
select as child records all records in tables other than the parent table for which the value of the redundant field is the same as the value of the redundant field in the parent record; and
identify as a child table a table that is not the parent table and that has the redundant field.

13. A computer system that can prepare a relational database having a many-to-one relationship for data mining, the computer system comprising:
a means for generating a hierarchical data tree based on a relational data model and
a means for performing a bottom-up summarization starting from the children and proceeding to the next higher level.

14. A computer system that can include many records in a child level with one record in a parent level for data mining, comprising:
a means for identifying a parent level record;
a means for selecting child-level records corresponding to the parent level record;
a means for characterizing the child-level records into a transformed field; and
a means for appending the transformed field to the parent-level record.

15. The computer system according to claim according to claim 14 further comprising:
a means for providing a record class;
a means for providing a characterizing function associated with the record class; and
a means for categorizing the selected child as members of the record class;
wherein the means for categorizing uses the characterizing function to determine the transformed field.

16. The computer system according to claim 15 wherein the means for providing a record class further comprises:
a means for providing as a first class time series records with a regular sampling interval, the characterizing function associated with the first class of records being a selected from the group of digital signal processing algorithms consisting of local cosine transform coefficients and linear predictive coding coefficients;
a means for providing as a second class of time series records having an irregular sampling interval, the characterizing function associated with the second class of records begin selected from the group consisting of trend analysis, Markov modeling, and statistical summarization., and
a means for providing as a third class of miscellaneous records having no apparent time dependence, the characterizing function associated with the third class of records being selected from the group consisting of statistical summarization and data association.

17. A computer system that can prepare a relational database for data-mining as a flat database, comprising:
a means for identifying a data model;
a means for generating a data hierarchy tree;
a means for collecting multiple events in child records associated with a parent record;
a means for characterizing the nature of multiple events in the child record;
a means for extracting features from the child records, where feature extraction depends on the nature of the multiple events in the child records;
a means for appending extracted features to the parent record; and
a means for repeating the method for all child records.

18. A computer system that can transform a relational database to a flat database, comprising:
a means for providing a relational database having a first table and a second table, each table having a plurality of records, each record having a plurality of fields, wherein a linked field in a selection record in the first table contains data corresponding to data in a linking field of a plurality of records in the second table;
a means for characterizing the data in a summarized field in the second database by computing summarization data, wherein the summarized field in the second database is not the linking field; and
a means for appending a summarization field to the first table; and
a means for storing the summarization data in the summarization field of the selection record in the first table.

19. A computer system that can apply a data mining technique for a flat database to a relational database, the comprising:
a means for providing a relational database having a parent table, parent-table records, a child table, and child-table records, wherein a plurality of child table records can be linked to a parent table record;
a means for converting the relational database to a flat database by appending to a parent table record at least one field summarizing the values in child table records linked to the parent table; and
a means for applying a flat database data mining technique to the flat database.

20. A computer system that can determine the relationships among tables in a database, the method comprising the steps:
a means for identifying potential primary key fields;
a means for determining table hierarchy that identifies tables as parent tables and related child tables;
a means for exploring intractable data relationships to reduce the size of a data table; and
a means for exploring inter-table data relationships between data in a parent table and data in a child table to that parent.

21. A computer system that can identify potential primary key fields, comprising:
a means for identifying a redundant field whose name appears in a plurality of tables;
a means for identifying as a parent table a table in which the value of the redundant field is unique for each record. whereby the redundant field is a primary key for the parent table;
a means for selecting as a parent record a record from the parent table, whereby the value of the redundant field of the parent record is unique in the parent table;
a means for selecting as child records all records in tables other than the parent table for which the value of the redundant field is the same as the value of the redundant field in the parent record; and
a means for identifying as a child table a table that is not the parent table and that has the redundant field.

22. A computer readable medium article of manufacture with instructions for the purpose of preparing a relational database having a many-to-one relationship for data mining, the medium comprising instructions that when executed:
generate a hierarchical data tree based on a relational data model and
perform a bottom-up summarization starting from the children and proceeding to the next higher level.

23. A computer readable medium article of manufacture with instructions for the purpose of including many records in a child level with one record in a parent level for data mining, the medium comprising instructions that when executed:
identify a parent level record;
select child-level records corresponding to the parent level record;
characterize the child-level records into a transformed field; and
append the transformed field to the parent-level record.

24. The computer readable medium according to claim 23 wherein the transformed field is one of a plurality of transformed fields.

25. The computer readable medium according to claim 23, further comprising instructions that when executed:
provide a record class;
provide a characterizing function associated with the record class; and
categorize the selected child as members of the record class;
wherein the step categorize step uses the characterizing function to determine the transformed field.

26. The computer readable medium according to claim 25, wherein the instructions that when executed provide a record class further comprises instructions that when executed:
provide as a first class time series records with a regular sampling interval, the characterizing function associated with the first class of records being a selected from the group of digital signal processing algorithms consisting of local cosine transform coefficients and linear predictive coding coefficients;
provide as a second class of time series records having an irregular sampling interval, the characterizing function associated with the second class of records begin selected from the group consisting of trend analysis, Markov modeling, and statistical summarization, and
provide as a third class of miscellaneous records having no apparent time dependence, the characterizing function associated with the third class of records being selected from the group consisting of statistical summarization and data association.

27. A computer readable medium article of manufacture with instructions for the purpose of preparing a relational database for data-mining as a flat database, the medium comprising instructions that when executed:
generate a hierarchical data tree based on a relational data model;
perform a bottom-up summarization of the data scattered across multiple tables; and
use a single table containing the summarized data for data mining.

28. A computer readable medium article of manufacture with instructions for the purpose of preparing a relational database for data-mining as a flat database, the medium comprising instructions that when executed:
identify a data model;
generate a data hierarchy tree;
collect multiple events in child records associated with a parent record;
characterize the nature of multiple events in the child record;
extract features from the child records, where feature extraction depends on the nature of the multiple events in the child records;
append extracted features to the parent record; and
repeat the method for all child records.

29. A computer readable medium article of manufacture with instructions for the purpose of transforming a relational database to a flat database, the medium comprising instructions that when executed:
provide a relational database having a first table and a second table, each table having a plurality of records, each record having a plurality of fields, wherein a linked field in a selection record in the first table contains data corresponding to data in a linking field of a plurality of records in the second table;
characterize the data in a summarized field in the second database by computing summarization data, wherein the summarized field in the second database is not the linking field; and
append a summarization field to the first table; and
store the summarization data in the summarization field of the selection record in the first table.

30. The medium according to claim 29 further comprising instructions that when executed repeat the characterizing step and the appending step for all records in the first table.

31. A computer readable medium article of manufacture with instructions for the purpose of applying a data mining technique for a flat database to a relational database, the medium comprising instructions that when executed:
provide a relational database having a parent table, parent-table records, a child table, and child-table records, wherein a plurality of child table records can be linked to a parent table record;
convert the relational database to a flat database by appending to a parent table record at least one field summarizing the values in child table records linked to the parent table; and
apply a flat database data mining technique to the flat database.

32. A computer readable medium article of manufacture with instructions for the purpose of determining the relationships among tables in a database, the medium comprising instructions that when executed:
identify potential primary key fields;
determine table hierarchy that identifies tables as parent tables and related child tables;
explore intra-table data relationships to reduce the size of a data table; and
explore inter-table data relationships between data in a parent table and data in a child table to that parent.

33. A computer readable medium article of manufacture with instructions for the purpose of identifying potential primary key fields, the medium comprising instructions that when executed:
identify a redundant field whose name appears in a plurality of tables;
identify as a parent table a table in which the value of the redundant field is unique for each record. whereby the redundant field is a primary key for the parent table;
select as a parent record a record from the parent table, whereby the value of the redundant field of the parent record is unique in the parent table;
select as child records all records in tables other than the parent table for which the value of the redundant field is the same as the value of the redundant field in the parent record; and
identify as a child table a table that is not the parent table and that has the redundant field.

34. A memory for storing data for analysis by a data mining application, the memory comprising:
a data structure stored in said memory comprising a flat database table;
a primary record in the database table reflecting one instance of a set of fields of data, the record being associated with a plurality of secondary records in a linked database table;
a raw data field in the database table containing raw data stored in the table; and
a transformed data field in the database table containing transformed data, the transformed data field in the primary record representing the plurality of secondary records associated with the primary record.

35. The memory according to claim 34 wherein the transformed data field is a statistic summarizing the values of the plurality of records associated with the primary record.

36. The memory according to claim 34 wherein the transformed data field is a computed transformation of the values of the plurality of records associated with the primary record.
